(19) United States
(12) Patent Application Publication
(10) Pub. No.: US 2013/0340203 A1
(43) Pub. Date: Dec. 26, 2013

(54) CLEANER HANDLE AND CLEANER HANDLE HOUSING SECTIONS

(71) Applicant: CUBE INVESTMENTS LIMITED, Aurora (CA)

(72) Inventors: J. Vern CUNNINGHAM, Aurora (CA); Paul CHARLEBOIS, Toronto (CA); Tasneem BABUL RAYANI, Waterloo (AU); Paul ARATO, Toronto (CA)

(73) Assignee: CUBE INVESTMENTS LIMITED, Aurora (CA)

(21) Appl. No.: 14/010,332

(22) Filed: Aug. 26, 2013

Related U.S. Application Data
(63) Continuation of application No. 11/662,495, filed on Mar. 15, 2007, now Pat. No. 8,516,653.
(60) Provisional application No. 60/610,557, filed on Sep. 17, 2004.

(51) Int. Cl. A47L 9/30; F21V 33/00; A47L 9/32

(52) U.S. Cl. CPC A47L 9/30; A47L 9/32; F21V 33/0044
USPC 15/324; 362/109

(57) ABSTRACT

Handle has status indicators viewable by operator while viewing location being cleaned and using handle in ordinary cleaning position, and light illuminating location being cleaned. Indicators are LED lamps. Light is an LED lamp. Microphone senses particles and illuminates an indicator. Indicators and light are provided in a housing section that forms part of a housing for handle. Housing section may be integrated with the remainder of the housing, or may be unit that fits into remainder of housing. Light has central axis generally parallel, within approximately five degrees from parallel, with cleaning axis of handle. Indicators each have a central axis generally parallel, within approximately 5 degrees from parallel, with cleaning axis of handle. The indicators have limited beam angle. Indicator viewable over grasping section of handle from towards distal end of handle. The cleaner may be a vacuum cleaner, which may be a central vacuum cleaner.

### CROSS-REFERENCE TO RELATED APPLICATIONS

This application claims priority from, and the benefit of, the filing date of U.S. patent application Ser. No. 11/662,495, which is national stage entry of PCT application no. PCT/CA2005/001420 filed Sep. 16, 2005, which claims priority to U.S. provisional application no. 60/610,557 filed 17 Sep. 2004 under title Cleaner Handle And Cleaner Handle Housing Sections. The contents of the above applications are hereby incorporated by reference into the MODE(S) FOR CARRYING OUT THE INVENTION herein.

### TECHNICAL FIELD

The invention relates to cleaner handles, and to housing sections therefor.

### BACKGROUND ART

Cleaners include vacuum cleaners, floor cleaners, and the like. Vacuum cleaners include all types of vacuum cleaners, such as, for example, central vacuum cleaners, canister vacuum cleaners and upright vacuum cleaners.

Makers of cleaners have been adding features to their cleaners in order to remain competitive. For example, illuminated indicators have been used for many years to provide information about the status of the cleaner to an operator. The indicators may provide information such as whether or not the cleaner is ON. These indicators are helpful for all cleaners. They are particularly helpful in cleaners that have components remote from a handle that an operator of the cleaner grasps while vacuuming, such as in a central vacuum cleaner.

The indicators have been placed on the handle itself. Originally these indicators used incandescent bulbs that emitted from a top surface of the handle. More recently, the indicators use LED lamps emitting from a top surface of the handle.

Lights have also been used on powered attachments at floor level to illuminate in front of the attachment while cleaning. Also, microphones have been used to sense dust particles moving through a cleaner.

Improvements or alternatives to currently available features for cleaners are desirable.

### DISCLOSURE OF THE INVENTION

In a first aspect the invention provides a cleaner handle for use on a cleaner. The handle has a grasping section for manipulating the cleaner, an indicator housing, and at least one indicator within the indicator housing. The indicator has a limited viewing angle and a central axis. The central axis is directed over and across the grasping section such that the indicator is within the view of an operator holding the grasping section in an ordinary vacuuming position.

The cleaner may be a vacuum cleaner. The cleaner may be a central vacuum cleaner. The cleaner may be a canister vacuum cleaner. The cleaner may be an upright vacuum cleaner.

The indicator may be an LED lamp. The indicator may be an LCD display. The central axis of the indicator may be generally parallel with a cleaning axis of the handle, the cleaning axis being a line from the handle to a location currently being cleaned by the cleaner. The central axis of the indicator may be directed approximately 5 degrees vertically above a cleaning axis of the handle, the cleaning axis being a line from the handle to a location currently being cleaned by the cleaner.

The handle may also have an illuminator housing, a light within the illuminator housing, the light for illuminating with visible light an area that is being cleaned with the cleaner. A central beam axis of the light may be generally parallel with a cleaning axis of the handle, the cleaning axis being a line from the handle to a location currently being cleaned by the cleaner. A central beam axis of the light may be directed within approximately 5 degrees vertically of a cleaning axis of the handle, the cleaning axis being a line from the handle to a location currently being cleaned by the cleaner.

The handle may have a distal end for receiving particles from a location being cleaned. The indicator may be located between the distal end and the grasping section. The handle may have an indicator housing section that houses the indicator. The indicator housing section may have an aperture with the indicator viewable through the aperture. The aperture may be raised such that the indicator is viewable over a hand of an operator that is grasping the grasping section.

The handle may have a particle sensor for sensing particles flowing through the handle during operation of the cleaner. The particle sensor may have a microphone for sensing sound emitted when particles collide with a conduit in the handle as the particles flow through the cleaner. The conduit may be made from metal. The microphone may be held against the conduit by a spring mechanism. The spring mechanism may be a biased curved plastic strip.

The indicator may be within the view of the operator when the operator is viewing a location being cleaned by the cleaner.

In a further aspect the invention provides a cleaner handle for use on a cleaner. The handle includes a grasping section for manipulating the cleaner, an indicator housing, and at least one indicator within the indicator housing, the indicator having a limited viewing angle and a central axis. The central axis is directed over and across the grasping section such that the indicator is within the view of an operator holding the grasping section and viewing a location being cleaned by the cleaner.

The view of the operator includes a line to the location that is generally parallel to a cleaning axis of the handle, the cleaning axis being a line between the handle and the location being cleaned.

The central beam axis of the indicator may be directed at least 5 degrees vertically above a cleaning axis of the handle, the cleaning axis being a line from the handle to a location currently being cleaned by the cleaner.

The indicator beam angle may be approximately 20.degree. The light may be one or more LED lamps. The beam angle of each LED lamp may be approximately 12.degree.

In a still further aspect the invention provides a cleaner handle section for attachment to a housing of a cleaner handle having a grasping section for manipulating the cleaner. The cleaner handle section includes an indicator housing section, and at least one indicator within the indicator housing section, the indicator having a limited viewing angle and a central axis. The central axis is directed over and across the grasping section such that the indicator is within the view of an operator holding the grasping section and viewing a location being cleaned by the cleaner.

In another aspect the invention provides a cleaner handle for use on a cleaner. The handle includes a grasping section for manipulating the cleaner, an indicator housing, and at least one indicator within the indicator housing. The indicator has a lamp for emitting a visible beam of light from the indicator housing with a limited beam angle and a central beam axis. The central beam axis is directed over and across the grasping section such that the beam is within the view of an operator holding the grasping section in an ordinary vacuuming position.

The indicator housing section may have an aperture and the beam of light may emit from the aperture. The aperture may be raised such that the indicator beam of light emits over a hand of an operator that is grasping the grasping section. The beam may be within the view of the operator when the operator is viewing a location being cleaned by the cleaner.

In yet another aspect the invention provides a cleaner handle for use on a cleaner. The handle includes a grasping section for manipulating the cleaner, an indicator housing, and at least one indicator within the indicator housing. The indicator has a lamp for emitting a visible beam of light from the indicator housing with a limited beam angle and a central beam axis. The central beam axis is directed over and across the grasping section such that the beam is within the view of an operator holding the grasping section and viewing a location being cleaned by the cleaner.

In still another aspect the invention provides a cleaner handle section for attachment to a housing of a cleaner handle having a grasping section for manipulating the cleaner. The cleaner handle section includes an indicator housing section and at least one indicator within the indicator housing section, the indicator including a lamp for emitting a visible beam of light from the indicator housing with a limited beam angle and a central beam axis. The central beam axis is directed over and across the grasping section such that the beam is within the view of an operator holding the grasping section and viewing a location being cleaned by the cleaner.

Other aspects of the invention are evident from the Mode(s) For Carrying Out The Invention herein.

### BRIEF DESCRIPTION OF THE DRAWINGS

For a better understanding of the present invention and to show more clearly how it may be carried into effect, reference will now be made, by way of example, to the accompanying drawings which show the preferred embodiment of the present invention and in which:

FIG. 1 is a side view of a handle in accordance with a preferred embodiment of the present invention,

FIG. 2 is a partial cross-section of a building containing a central vacuum cleaner utilizing the handle of FIG. 1;

FIG. 3 is a top view of the handle of FIG. 1;

FIG. 4 is a perspective view from above, to the rear and to one side of a portion of the handle of FIG. 1;

FIG. 5 is a perspective view from above, to the front, and to one side of the handle of FIG. 1;

FIG. 6 is a cross-section of a portion of the handle of FIG. 1 along the line A-A′ of FIG. 3;

FIGS. 7-12 are side views of alternate embodiments of a handle in accordance with an embodiment of the present invention;

FIG. 13 is a perspective view of an upright vacuum cleaner utilizing a handle in accordance with an embodiment of the present invention;

FIG. 14 is a side view of an alternate embodiment of a handle in accordance with an embodiment of the present invention. and

FIG. 15 is a partial cross-section of a building containing a central vacuum cleaner utilizing the handle of FIG. 1.

### MODE(S) FOR CARRYING OUT THE INVENTION

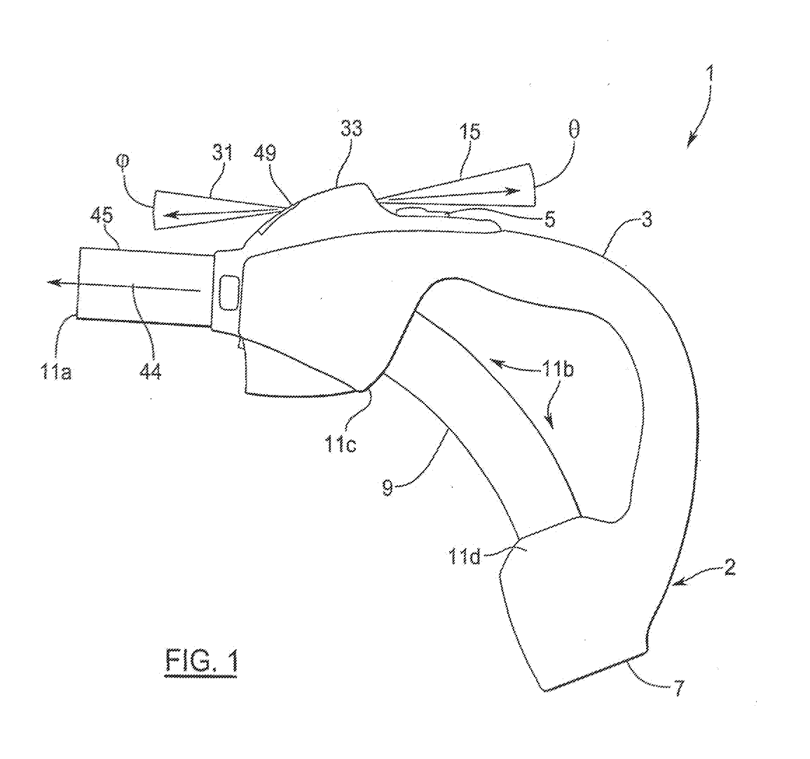

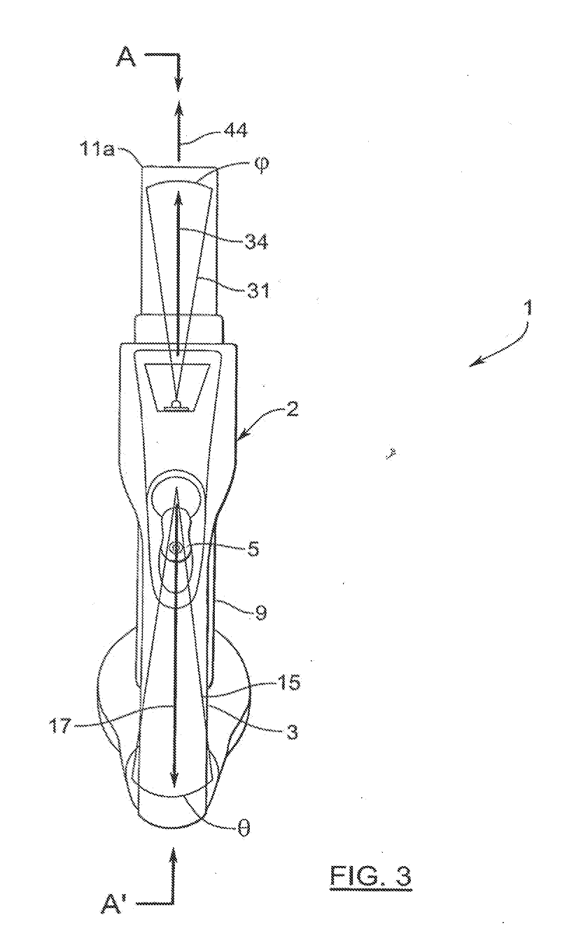

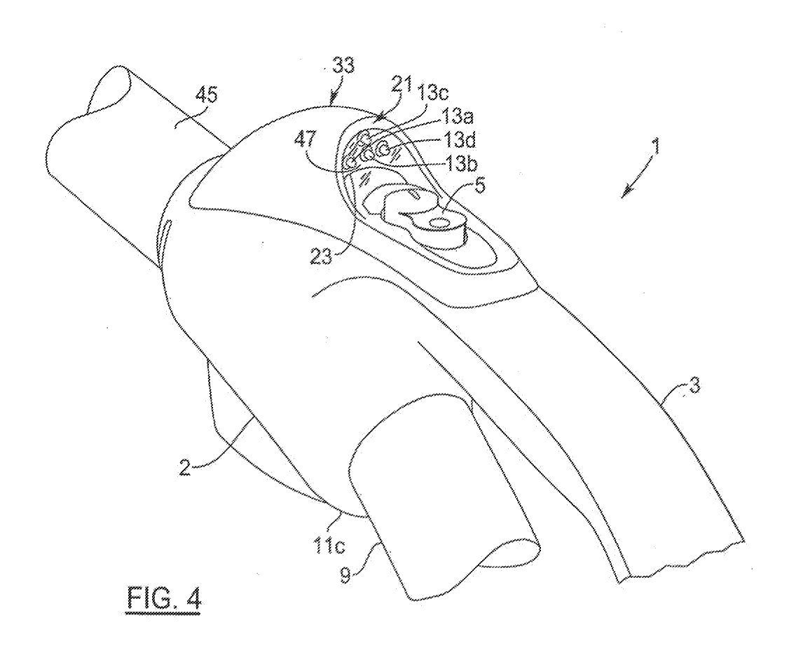

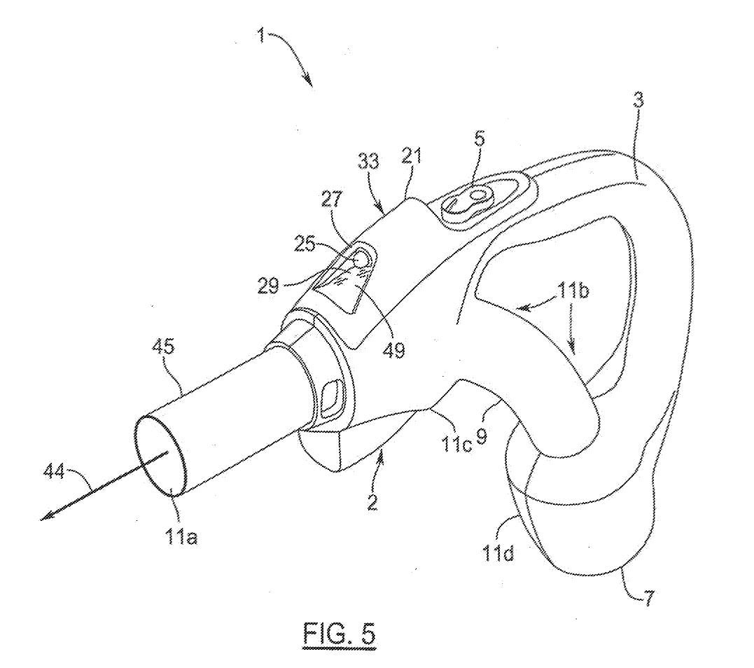

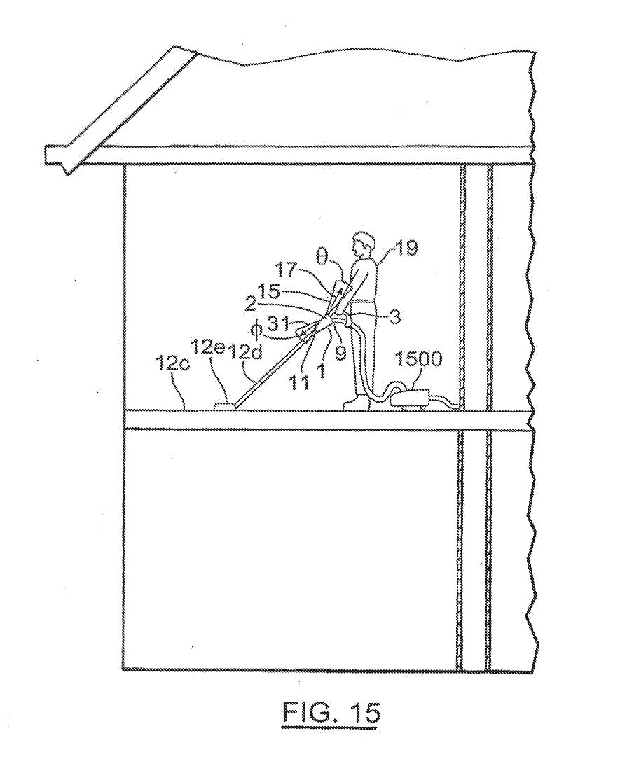

Referring to FIGS. 1 through 7, a cleaner handle 1 has a housing 2 with a grasping section 3, a control input 5 (a two-way button switch is shown for the control input 5 in the FIGS.), and a hose receiver 7. The handle 1 also has a generally tubular conduit 9. The hose receiver 7 receives a vacuum hose 10 and provides fluid connection from the hose 10 to the conduit 9. The conduit 9 has a distal end 11a that is open to draw in particles through the conduit 9 for transfer to the hose 10. The vacuum hose 10 may be connected to a wall outlet 12a in the case of a central vacuum cleaning system 12b, or to a vacuum canister in the case of a canister vacuum (see for example FIG. 15). The grasping section 3 is connected to the conduit 9 to allow a user of the vacuum cleaner to grasp the grasping section 3 and manipulate the conduit 9 to vacuum clean a desired location, such as a floor 12c.

The conduit 9 is typically separate from the housing 2 and made of metal, such as chromed steel, and, for this reason is sometimes referred to as a “metal wand”; however, the conduit 9 could be made from plastic or another rigid material. Also, the conduit 9 may be integrated with the housing 2. Where the conduit 9 is separate from the remainder of the housing 2, the housing 2 must have a conduit holder 11b. In the handle 1, the conduit holder 11b is provided in two conduit holder portions 11c, 10d. The distal end 11a of the conduit 9 may receive attachments, such as conduit extensions 12d for cleaning locations further away from the handle, carpet sweepers 12e, brushes (powered and unpowered), crevices tools, and the like, not shown.

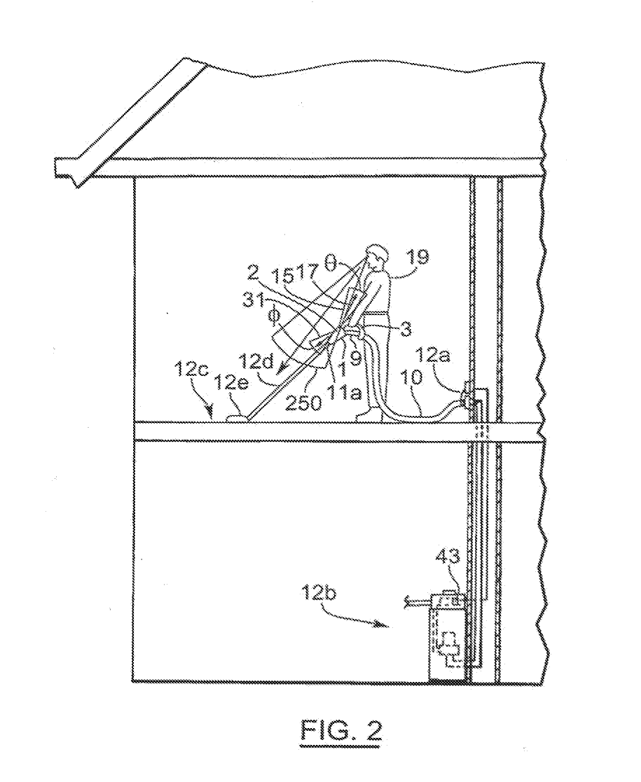

Between the grasping section 3 and the distal end 11a, the handle 1 has indicators 13 (shown individually as 13a, 13b, 13c, 13d in the FIGS.). Each indicator 13 is a lamp for emitting a visible beam of light 15 from the housing 2. The beam of light 15 has a limited bandwidth .theta. and a central beam axis 17. Each beam of light 15 is directed towards an operator 19 when the operator 19 is in an ordinary vacuuming position, such as cleaning a floor when standing as shown in FIG. 2. Each beam 15 is in a view 250 of the operator 19 when the operator 19 is using the handle 1 in an ordinary vacuuming position. The beam 15 is in the view 250 of the operator 19 when the operator 19 is using the handle and viewing a location 12c being cleaned. For clarity, in the FIGS. only a beam of light 15 for a single indicator 13 is shown. It is understood that each indicator will have its own beam of light 15.

Preferably, each indicator 13 is an LED lamp. LED lamps have many benefits, any one of which may be desirable to a designer creating a handle in accordance with the principles described herein. LED lamps are relatively inexpensive, small, efficient (drawing little energy when compared to light output), output less heat than most other light sources, and are long lasting. In addition, they are available in many colours, including multi-coloured LED lamps, and can be mounted on a printed circuit board.

In the preferred embodiment there are four indicators 13a, 13b, 13c, 13d. Indicators 13a, 13b, 13d are green, while indicator 13c is red. Illumination of indicator 13c indicates that particles are flowing through the conduit 9. The manner in which this is sensed in the preferred embodiment will be discussed later below. If no particles are sensed flowing through the conduit 9 then indicator 13c is off and indicator 13a is illuminated. When the cleaner is on, indicator 13b is illuminated, and if a power brush is attached and turned on then indicator 13d is illuminated. Other colours may be used, such as, for example, readily available amber, yellow or blue LEDs. Greater or fewer indicators 13 may be used. The indicators 13 may be multi-coloured to indicate a plurality of conditions with a single indicator. Also, the indicators 13 may illuminate according to different timing patterns to indicate different conditions.

As a further example, the indicators 13 may be an LCD display of compatible size. An LCD display has many of the advantages of LEDs including relatively low cost and low power draw. An LCD display can be driven to display icons for the indication of different conditions such as those discussed above. The LCD display may be backlit such that the LCD display is an indicator emitting a visible beam of light 15 from the face of the LCD display with a limited beam angle .THETA. and a central axis 17. If the LCD display is not backlit, then the icons may simply have contrasting shades that are viewable when the LCD is lit by ambient light. In this case, the direction of the LCD display from a central point of the screen (the “central axis”) is equivalent to the central beam axis 17. Similarly, the viewing angle of the LCD display will be equivalent to the angle .THETA. and the area within the viewing angle will be equivalent to the beam of light 15.

The central beam axes 17 are directed from between the distal end 11a and the grasping section 3 in the view of an operator 19 using the handle 1 in an ordinary vacuuming position. The central beam axes 17 are directed over and across the grasping section 3 from between the distal end 11a and the grasping section 3.

The indicators 13 are in an indicator housing section 21 of the housing 2. The indicator housing section has an aperture 23 through which the beams of light 15 emit from the housing 2. The aperture 23 in the indicator housing section 21 in the handle 1 is raised above the grasping section 3 in order to allow the central beam axes 17 to pass over and across the grasping section 3 without being blocked by the hand of the operator 19, or other components such as, for example, the switch 5.

The handle 1 also has a light 25 for emitting visible light for illuminating a location 12c to be cleaned. The light 25 is one or more LED lamps 25 (one lamp 25 is shown in the FIGS.). The LED lamp 25 outputs greater light intensity than the indicator 13, as the lamp 25 is intended to illuminate the location 12c. The intensity of the light 25 may be selected to illuminate an area 12c that is close to the handle, for example for use when the handle 1 is used without extensions 12d. Alternatively, the intensity may be selected to illuminate both a close location 12c, and a location that is further from the handle 1 when the handle 1 is used with one or more extensions 12d. The light preferably emits white light; however, other wavelengths could be used as desired by a designer of the handle, such as red, green, amber, yellow or blue.

The light 25 is in an illumination housing section 27 of the housing 2 between the grasping section 3 and the distal end 11a. The illumination housing section 27 has an aperture 29 through which a beam of light 31 shines toward a location 12c to be cleaned. In the handle 1, the illumination housing section 27 is closer to the distal end 11a of the handle 1, while the indicator housing section 21 is closer to the grasping section 3; so that, the illumination housing section 27 and the indicator housing section 21 do not block their respective beams of light 15, 31. In the handle 1, the illumination housing section 27 and the indicator housing section 21 are integrated as a single illumination indicator housing section 33.

The beam of light 31 has a limited beam angle .PHI. and a central beam axis 34. The central beam axis 34 is directed towards the location to be cleaned 12c. The beam angle .PHI. is selected to illuminate a desired amount of the area to be cleaned at a given distance. If the intensity of the light is selected for close work only, then the beam angle .PHI. could be broader than for illumination of an area 12c that is further away. Suitable LED lamps include Lite-on, Inc. of Milpitas, Calif. part no. LTL33BCWK5AT or Kingbrite of City of Industry, Calif. part no. W7524PWC\H. The Kingbrite lamp has a beam angle .PHI. of approximately 12 degrees and an intensity of approximately 7500 mcd. It is to be recognized that additional optics could be provided to allow the beam angle .PHI. to be altered when in use.

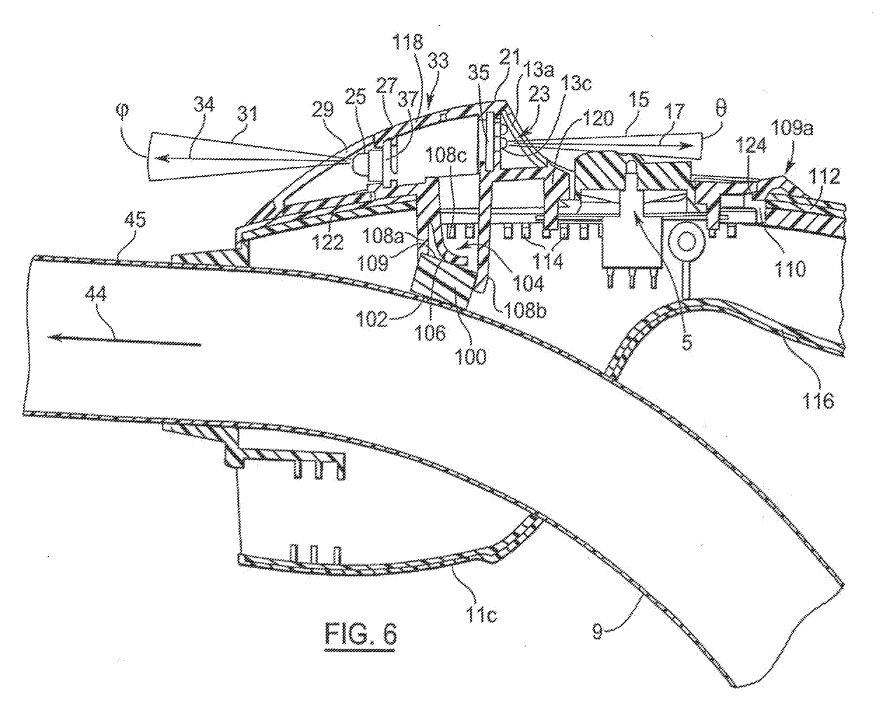

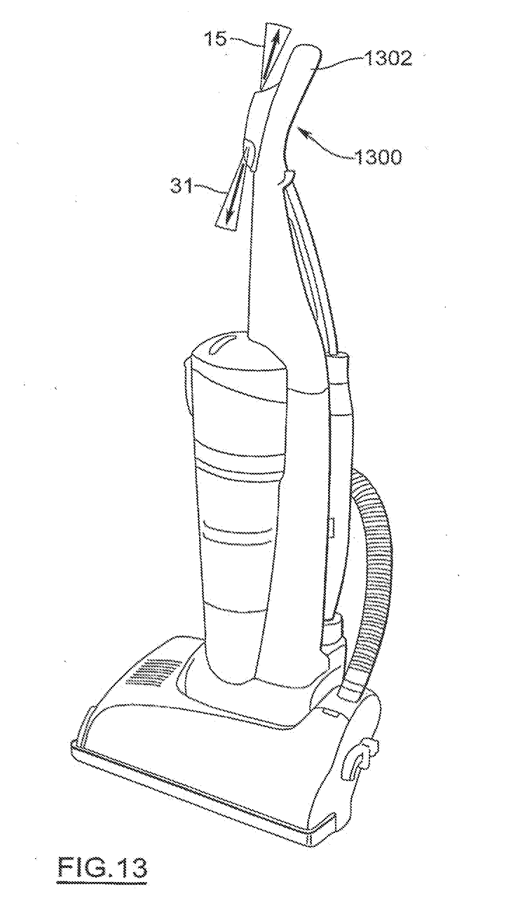

Referring in particular to FIG. 6, the indicators 13 (13a and 13c are shown in the FIG.) are mounted on a printed circuit board 35, while the light 25 is mounted on a printed circuit board 37. Another printed circuit board, not shown is mounted within the housing 2 with a control circuit, including a microprocessor for controlling operation of the handle 1. For clarity, wiring connections between the various boards 35, 37, the control circuit board and other components within the handle 1, such as hose receiver 7, are not shown. In a wired control application, low voltage wires extend from the handle 1 through the hose receiver 7 and hose 10 to a central vacuum suction unit 43 (FIG. 2), or to a canister vacuum (see for example FIG. 15) or to another vacuum cleaner suction unit, such as a suction motor of an upright vacuum (see for example FIG. 13). Wireless control is also possible, for example, as described in a co-pending United States patent application of J. Vern Cunningham entitled Central Vacuum Cleaning System Control Subsystems filed 9 Sep. 2004, application number not yet known, the content of which is hereby incorporated by reference into the detailed description hereof.

It has been found that it is acceptable for the beam of light 15 central axis 17 to emit substantially parallel to a cleaning axis 44 of the handle 1, provided that the beam angle .theta. is broad enough to remain in the view of an operator in ordinary cleaning positions. The view of the operator typically includes a line generally parallel to the cleaning axis 44 to a location being cleaned. The angle between the view 250 of the operator to the location being cleaned and the cleaning axis 44 will vary as the operator moves about during cleaning. In the preferred embodiment the central axis 17 of the beam of light 15 is angled vertically away from the cleaning axis 44 at an angle of approximately 5 degrees. Suitable LED lamps include Kingbrite of City of Industry, Calif. part no. KM2520A01SGC (green) and KM2520A01SRC003 (red) with a beam angle of approximately 20 degrees and an intensity of approximately 100 mcd in the configuration of the handle 1. Again, the particular angle between the cleaning axis 44 and the central axis 17, and the particular beam angle .theta., chosen will depend on the particular configuration for the handle 1. In addition to allowing clearance of other components of the handle 1 (such as switch 5) and a hand of an operator 19, a central axis 17 with a slight upward angle from the cleaning axis 44 may align the central axis more closely with an eye of a typical operator 19 using the handle 1 in an ordinary cleaning position.

The cleaning axis 44 is a line from the distal end 11a to a location 12c that is currently being cleaned. The cleaning axis 44 is typically perpendicular to the distal end 11a of the handle 1. Typically, the distal end 11a has a straight portion 45 for receiving attachments, such as those described previously. This straight portion typically defines the cleaning axis 44 of the handle 1. Similarly, it has been found that acceptable for the beam of light 31 central axis 34 to emit substantially parallel to the cleaning axis 44. In the preferred embodiment the central axis 34 is vertically angled toward the cleaning axis 44 at an angle of approximately 5 degrees.

Accordingly, in the handle 1 the indicators 13 are surface mounted to the printed circuit board 35. The printed circuit board 35 is mounted generally perpendicular to the cleaning axis 44, offset by approximately 5 degrees vertically in the preferred embodiment. Similarly, in the handle 1 the lamps 25 are surface mounted to the printed circuit board 37. The printed circuit board 37 is mounted generally perpendicular to the cleaning axis 44, offset by approximately 5 degrees vertically in the preferred embodiment. Thus, the indicators 13 and the lamps 25 are mounted such that their central axes 17, 34 are substantially parallel with one another; although, the respective beams of light 15, 31 emit in opposite directions. The indicators 13 and the lamps 25 are generally in line with one another, save and except for design limitations, such as, for example, a required distance between respective indicators 13 to allow them to be physically distinguished.

The aperture 23 is covered by a protective transparent lens 47 to prevent damage to the indicators 13 and other components of the handle 1. The aperture 23 is curved inwardly for aesthetic appeal and also to provide a visual indication of the location of the switch 5. Similarly, the aperture 29 is covered by a protective lens 49. The lens 49 can be transparent, or it may be translucent to diffuse the beam of light 31 and to hide internal components. The lens 49 may have other optical qualities dependent on the characteristics desired for a given application. The lens 49 is curved outwardly to provide a smooth external surface for the illumination housing section 27.

The housing 2 also contains a microphone 100 that rests against a section 102 of the conduit 9 that is impacted by particles in the conduit 9 when in use. Typically the section 102 is an outside of a bend in the conduit 9 that forces the particles against the conduit 9. Preferably the conduit 9 made of a material that transmits sound well, such as the chromed metal typically used in “metal wands”. The microphone 100 is connected to the control circuit and transmits sounds caused by particles colliding with the conduit 9 to the control circuit for use in controlling the handle 1 and, possibly, the cleaning system of which it is a part. The microphone 100 acts as a particle sensor. In the preferred embodiment, one of the indicators 13c illuminates when particles are sensed, and indicator 13a illuminates when particles are not sensed. This provides a visual indication to the operator 19 of particles at the location 12c being cleaned. Among other things, the operator 19 may use this information to go back over that location until no further particles are sensed, or as a prompt to consider why particles are being found in a particular location.

The microphone 100 is held against the conduit 9 using a spring mechanism 104. In the handle 1, the spring mechanism 104 is a plastic strip 106 that is curved and biased toward the conduit 9 up against the microphone 100. The microphone 100 is held laterally by four fixed plastic strips 108a, 108b, 108c (the fourth strip is not shown in FIG. 6) that allow the microphone 100 to slide upwardly against the spring mechanism 104, or for removal for replacement or repair. The strip 106 extends downwardly from the strip 108a. In the preferred embodiment the microphone 100 is in the form of a cylinder enclosed in rubber. The rubber assists in dampening vibrations at the microphone 100. Wires, not shown, extend from the top 109 of the microphone 100. The spring mechanism 104 is located to avoid the wires on the top 109 of the microphone 100. There are many other configurations of microphone that may be used in the handle 1, with or without the particular sprig mechanism described herein. Other spring mechanisms could be used to bias the microphone 100 against the conduit 9.

The indicator housing section 21 and the illuminator housing section 27 can be integrated with one another, as in the indicator illuminator housing section 33. The indicator illuminator housing section 33 may be integrated with the remainder of the housing 2. In this case, the housing 2 would typically be provided as two halves along the cross-section line shown in FIG. 6. This is commonly referred to as a “clamshell” configuration.

Alternatively, the illuminator indicator housing section 33 could be provided as a separate unit 109 that is mounted to the remainder of the housing 2. This is particularly advantageous for retrofit applications to an existing handle. This is the configuration shown in the FIGS. for handle 1. The illuminator indicator housing section 33 fits into an existing control opening 110 in the housing 2, covering the opening 110. The section 33 has a flange, not evident in FIG. 6, that fit beneath an outer shell 112 of housing 2 and rests on ribs 114 extending from the interior of the shell 112. For assembly, the unit 109 is placed in one “clamshell” half 116 and another clamshell half, not shown in FIG. 6, is mounted over the unit 109 to the clamshell half 116. This fastens the unit 109 to the remainder of the housing 2, and provides a simple way to removably retain the illuminator indicator housing section 33 against the remainder of the housing 2. The microphone 100 and related components, control circuit and wiring are mounted in the unit 109 and clamshell half 116 before the second clamshell half is assembled. The clamshell halves are generally mirrors of one another, and the unit 109 is generally symmetrical about the cross-section line of FIG. 6.

For ease of manufacture and assembly, the unit 109 is made from two pieces of moulded plastic: a top portion 118 and a bottom portion 120. The other components of the unit 109, including, for example, switch 5, boards 35, 37 and lenses 47, 49 fit into or between the top portion 118 and bottom portion 120. The top portion 118 is held to the shell 112 by the bottom portion 120 at raised flange 122 of bottom portion 120 in the front and at lowered flange 124 of top portion 118 in the rear. The unit 109 is assembled prior to insertion in the clamshell half 116.

Alternatively, the unit 109 could be snap fitted into the opening 110 after the clamshell halves are mated. Any necessary wiring would need to be connected before the clamshell halves are mated, or be brought out of the opening for connection to the unit 109. The unit could be retained in the opening using, for example, resilient tabs. Alternatively, the unit 109 can be mounted is screws or other such fastening means.

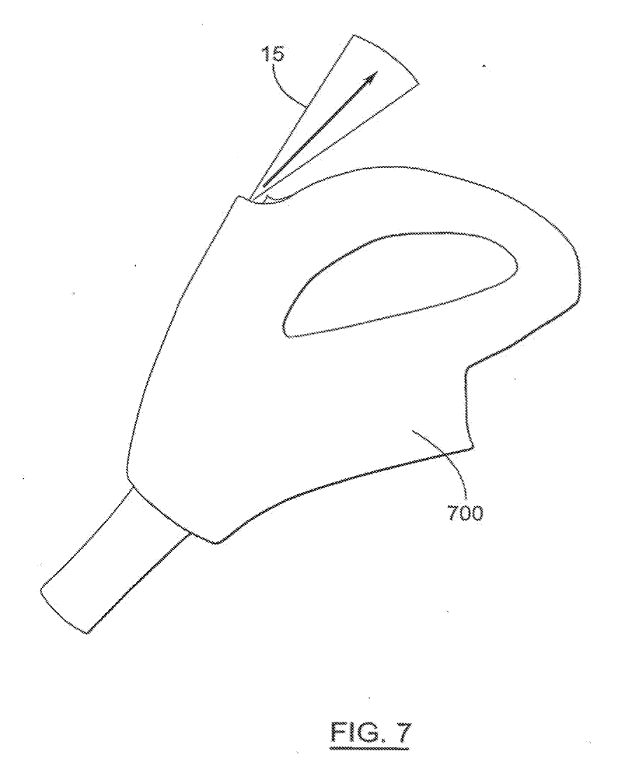

Referring to FIGS. 7-14, cleaner handles can come in many different configurations. Examples of embodiments utilizing various principles as described herein are shown. It is to be understood that these are examples embodiments only and are not intended as a complete review of all possible embodiments. It will be evident to those skilled in the art based upon the principles described herein that many more embodiments are possible. In these alternate embodiments like reference numerals will be used for like components and the description will not be repeated. The components of the handle 1 can be used in the other embodiments as desired for the particular embodiment.

Referring to FIG. 7, a hose handle 700 has one or more indicators that each emit a beam of light 15 to an operator. The handle 700 has a more rounded design than that of the handle 1. The handle 100 does not have a light for illumination of a location to be cleaned.

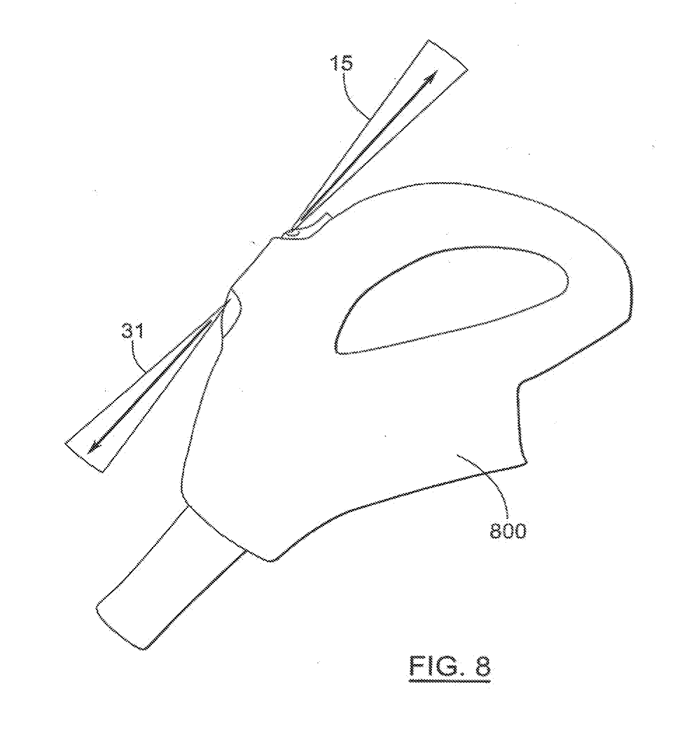

Referring to FIG. 8, hose handle 800 is similar to hose handle 700, except that the handle 800 has a light 25 that emits a beam 31 to a location to be cleaned.

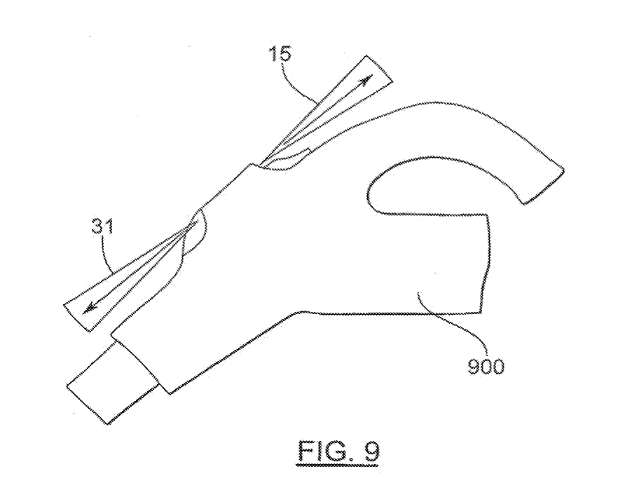

Referring to FIG. 9, a hose handle 900 has an open handle configuration. The handle 900 has one or more indicators that each emit a beam of light 15 to an operator, and a light 25 that emits a beam 31 to a location to be cleaned.

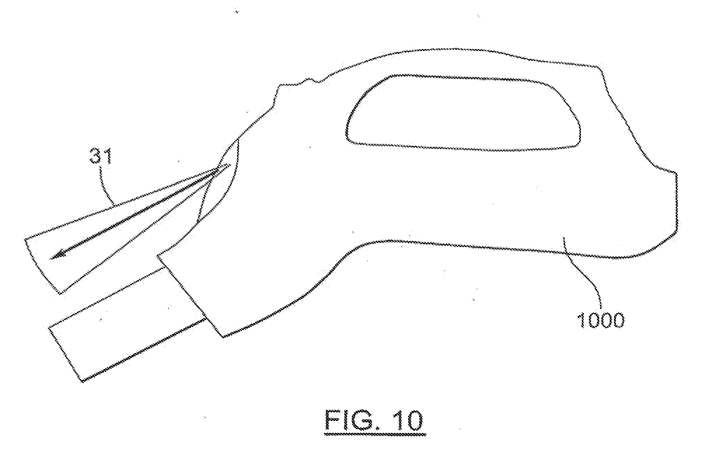

Referring to FIG. 10, a hose handle 1000 has a less-rounded closed configuration. The handle 1000 also has a light that emits a beam of light 31 to a location to be cleaned.

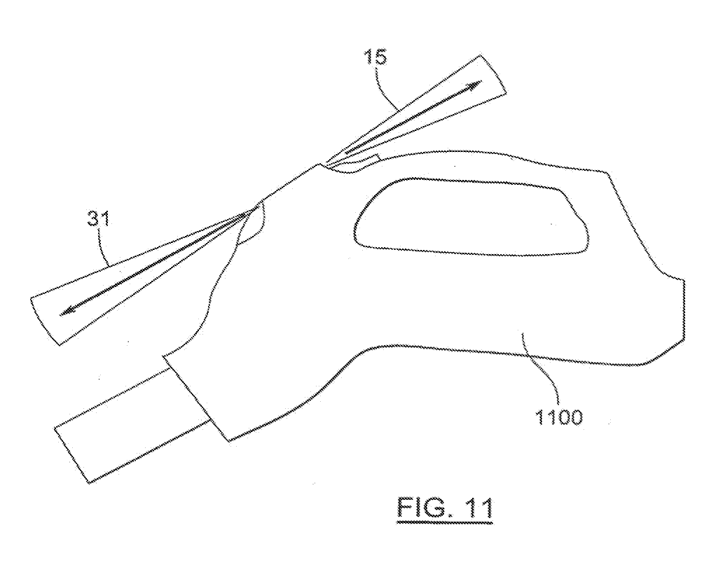

Referring to FIG. 11, a hose handle 1100 is similar to handle 1000, except that the handle 1100 also has indicators that emit beams of light 15 to an operator.

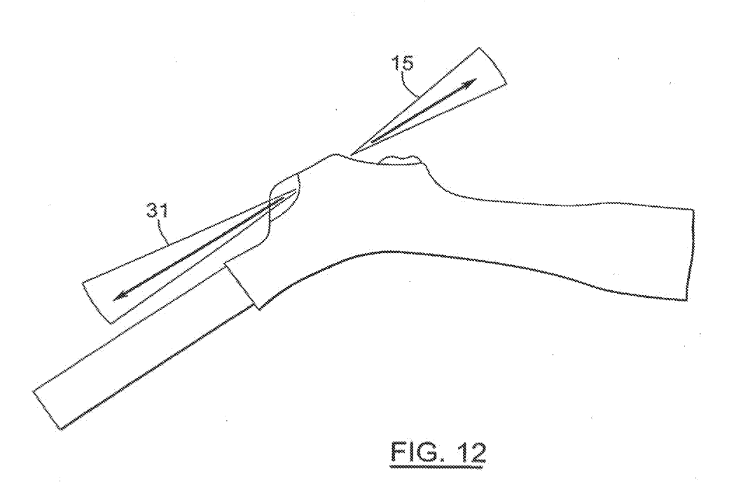

Referring to FIG. 12, a hose handle 1200 has a pistol configuration. The handle 1200 has indicators that emit a beam of light 15 to an operator, and a beam of light 31 to a location to be cleaned.

Referring to FIG. 13, an upright vacuum cleaner 1300 has a handle 1302 that has indicators that emit a beam of light 15 to an operator, and a beam of light 31 to a location to be cleaned.

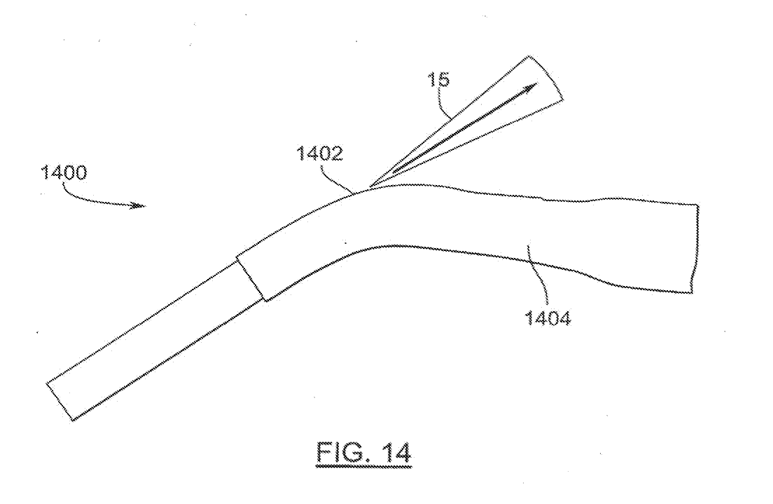

Referring to FIG. 14, although it is preferable to have a raised housing section 21, a handle 1400 has an indicator that is placed at an angle to surface 1402 of handle housing 1404. The angle is selected to direct a beam of light 15 from the indicator such that the beam of light falls within the view of the operator when using the handle in an ordinary vacuuming position. The orientation of the beam of light may be parallel to a cleaning axis of the handle 1400, or it may be oriented upwardly to avoid obstructions, such as a hand of the operator on the handle.

The beam of light 15 could be emitted perpendicular to the surface of a handle, provided that the surface was oriented to allow beam of light 15 to be in view of the operator when using the handle in an ordinary vacuuming position.

Referring to FIG. 15, a handle 1 is used in association with a canister vacuum cleaner unit 1500.

Clearly, many different embodiments based on the principles described herein are possible. Beams of light can be emitted from a lamp at a cleaner handle to illuminate a location to be cleaned. Beams of light can be directed from an indicator of a cleaner handle to an operator and be viewable when the handle is used in an ordinary cleaning position. The illumination lamp and the indicator can be provided separately, or provided on the same handle. The beams of light can have a limited viewing angle.

It will be understood by those skilled in the art that this description is made with reference to the preferred embodiment and that it is possible to make other embodiments employing the principles of the invention which fall within its spirit and scope as defined by the following claims.

1. A cleaner handle for use on a cleaner, comprising:
a first distal end where particles are to be drawn into the handle and a hose receiver at a second distal end for connection to a suction hose where the particles are to be drawn out of the handle;
a grasping section for manipulating the cleaner; and
an illuminator housing and a light within the illuminator housing, the light being oriented to illuminate with visible light an area that is being cleaned with the cleaner.

2. The cleaner handle of claim 1 wherein the light is located between the grasping section and the first distal end.

3. The cleaner handle of claim 1 wherein the first distal end comprises a straight tubular portion having a longitudinal axis, wherein the light is directed to illuminate in a direction of the longitudinal axis.

4. The cleaner handle of claim 3 wherein the first distal end and the second distal end are located at opposite ends of a tubular conduit that includes a curve or bend such that the second distal end is not aligned with the longitudinal axis.

5. The cleaner handle of claim 3 wherein a central beam of the light is generally parallel with the longitudinal axis.

6. The cleaner handle of claim 3 wherein a central beam of the light is directed within approximately 5 degrees vertically of the longitudinal axis.

7. The cleaner handle of claim 1 wherein the light includes an LED lamp having one or more LEDs.

8. The cleaner handle of claim 1 wherein one or more tubular extensions can be connected to the first distal end, the intensity of the light being selectable to illuminate both an area that is being cleaned close to the handle when the cleaner handle is used without tubular extensions and an area that is being cleaned at a distance from the handle when the cleaner handle is used with the one or more tubular extensions.

9. The cleaner handle of claim 1 wherein the light is mounted on a printed circuit board housed in the illuminator housing between the grasping section and the first distal end.

10. The cleaner handle of claim 1 wherein the cleaner is a central vacuum cleaner.

11. The cleaner handle of claim 1 wherein the cleaner is a canister vacuum cleaner connected to the second distal end by the suction hose.

12. A vacuum cleaner system comprising:
a vacuum cleaner handle having a first distal end where particles are to be drawn into the handle and a second distal end where the particles are to be drawn out of the handle;
a flexible suction hose having a first end connected to the second distal end of the handle and a second end in fluid communication with the first end; and
a vacuum source to apply suction to the second end of the suction hose;
the vacuum cleaner housing including a grasping section for manipulating the cleaner, an illuminator housing and a light within the illuminator housing, the light being oriented to illuminate with visible light an area that is being cleaned with the cleaner system.

13. The vacuum cleaner system of claim 12 wherein the first distal end of the handle comprises a straight tubular portion having a longitudinal axis, wherein the light is directed to illuminate in a direction of the longitudinal axis.

14. The vacuum cleaner system of claim 13 wherein the light is located between the grasping section and the first distal end of the handle, and the first distal end and the second distal end are located at opposite ends of a tubular conduit that includes a curve or bend such that the second distal end is not aligned with the longitudinal axis.

15. The vacuum cleaner system of claim 13 wherein a central beam of the light is generally parallel with the longitudinal axis.

16. The vacuum cleaner system of claim 13 wherein a central beam of the light is directed within approximately 5 degrees vertically of the longitudinal axis.

17. The vacuum cleaner system of claim 13 wherein the light includes an LED lamp having one or more LEDs.

18. The vacuum cleaner system of claim 13 comprising one or more rigid tubular extensions for connection to the first distal end of the handle to extend along the longitudinal axis, the intensity of the light being selected to illuminate both an area that is being cleaned close to the handle when the cleaner handle is used without the tubular extensions and an area that is being cleaned at a distance from the handle when the cleaner handle is used with the one or more tubular extensions.

19. The vacuum cleaner system of claim 12 wherein the vacuum source is part of a central vacuum cleaner.

20. The vacuum cleaner system of claim 12 wherein the vacuum source is part of a canister vacuum cleaner.
